(19) United States
(12) Patent Application Publication
(10) Pub. No.: US 2010/0257443 A1
(43) Pub. Date: Oct. 7, 2010

(54) System and Process for Producing a Two-Layer Document, and a Two-Layer Document Produced Accordingly

(75) Inventors: Dror Zernik, Haifa (IL); Itai Nahshon, Haifa (IL); Shahar Nanes, D.N.Hefer (IL)

Correspondence Address: MARSTELLER & ASSOCIATES, P O BOX 803302, DALLAS, TX, 75380-3302, US

(73) Assignee: E-GLUE SOFTWARE TECHNOLOGIES LTD., D.N. Hefer (IL)

(21) Appl. No.: 12/746,650

(22) PCT Filed: Dec. 10, 2007
(86) PCT No.: PCT/IL07/01523

§ 371 Date: Jun. 7, 2010

(51) Int. Cl. G06F 17/21; G06F 17/24

(52) U.S. Cl. 715/239; 715/256

(57) ABSTRACT

The present invention relates to a system for the preparation of an extended, two layer document, said extended document forms a single package which comprises a text document and a meta-data layer program attached to it, said system comprises a meta-data layer editor, which in turn comprises: (a) a document connector module for receiving a text document, and for parsing the document to document elements; (b) rules editor for defining rules concerning the content of each meta-data layer element, rules concerning to the form of appearance of each meta-data layer element, and action rules concerning conditions for activation of meta-data layer elements, wherein meta-data layer elements correspond to selected document elements of said locked text document; (c) program generator for generating from said rules an intermediate meta-data layer program; and wherein said system further comprises at least one converter for receiving a copy of said locked document and also receiving said intermediate program from said program generator, and for converting the same to said two layer extended document.

### FIELD OF THE INVENTION

The field of the invention generally relates to systems and methods for the production of electronic documents, and to viewers for displaying said electronic documents on electronic displays. More particularly, the invention relates to a system and method for the production of a two-layer electronic document, wherein the electronic document comprises: (a) a first layer being a “locked” document, such as a conventional PDF document; and (b) a second layer which includes additional visual information relating to specific portions of the “locked” document. This layer provides meta-data, or additional help that is not necessarily a part of the original locked document, but complements and supports the user interaction with the original document, or provides additional business values.

### BACKGROUND OF THE INVENTION

In today's working environment, documents are published in several common formats, mostly using HTML, .DOC, .PS and Adobe's PDF formats. The ability to send such documents to recipients over the Internet and to display them at the recipient side by means of free software viewers makes the documents publishing and their electronic transfer extremely appealing. Among the free viewers, the leading ones are the web browsers, such as the Internet Explorer and Mozila Firefox, and for PDF the most common browser is the Adobe Acrobat Reader.

The PDF format has been widely accepted as a means for sending pseudo- or fully authenticated electronic documents. In order to generate an Adobe's PDF file, a PDF writer is used. The PDF writer receives documents that have been previously edited in various formats, such as Word, Excel, or HTML, and can be easily converted to the PDF document format. Practically, any application that provides “print” capabilities can be configured to generate a PDF file, instead. A PDF formatted document is an electronic file, which can be viewed electronically using the appropriate viewer, such as Adobe's Reader, and is displayed exactly as it would have been if printed. Moreover, a document in PDF format is essentially locked, and the document cannot be altered after, its conversion to PDF. Electronic signature can be embedded in the PDF file as well, to provide an improved assurance that no unauthorized changes have been made to the document.

In one example, and with the widespread availability of PDF viewers at the client sides, many companies send by email to their customers bills in a PDF format, either by attaching the PDF file itself or a link to the bill which is stored at the company web site, or FTP server. This electronic mailing alternative reduces the handling costs and standard mail expenses, and further, it attracts the customer back to the company web-site.

While HTML-based documents and their browsers naturally support interactive mode, and JavaScript interpretation, PDF has only recently began to provide support for JavaScript within the viewer. Accordingly also PDF documents may become interactive.

In still another aspect, customers typically receive from the company forms, in which several fields need information insertion. The user in turn can fill information within the form fields, for submission back to the company, all of which, through PDF-based forms.

In another, more general alternative, documents of various types (WORD, EXCEL, HTML, etc.) that are sent to recipients have become complex and interactive: The recipients view documents which have a complex internal structure, with multiple internal dependencies and links. Some fields contain data which is derived from several other fields; other fields are interactive, where the recipient can fill information for submission back to the company. As said above, this latter option is obvious for HTML, but is possible also for PDF, Excel and Word documents.

Presently, the publishing (i.e., forming the document and sending to a recipient) mechanism of documents provides only a single layer. It does not provide a mean for editing and then publishing the content of said additional layer. Further, while it is possible to program such additional layer for any of the needed formats, it is not possible to generate such a layer in a manner which is consistent over all the document formats that are mentioned so far. Furthermore, the only way which is presently available to provide “help”, and content-sensitive services to a PDF document involves JavaScript programming. There is no non-programming manner to provide such a content-sensitive or help (meta-data) layer. Accordingly, in order to include explanations for how to fill the various fields of a PDF document such as a form, the document supplier is presently required to program said “meta-data” fields using JavaScript.

Although, as said, PDF viewers support the interpretation of associated JavaScript (such as conditional functions with multiple texts that appear on a separate layer) with specific fields of a generated PDF document, the only way presently existing to generate this associated JavaScript programs is to program these additional capabilities. Typically, document publishing tools focus on the capabilities to generate a high quality graphical object, sometimes with multiple graphical layers, and with precise content. However, none of said tools provides an interface which includes a non programming editorial tool having graphical capabilities (for example, similar to those that are as provided for generating the basic document, i.e., the document before publishing) also for the purpose of generating a meta-data layer (for example, a layer for the purpose of adding help features). Furthermore, the prior art does not provide a single, non programmable editorial tool which is capable of producing a single meta-data layer template, which can then be transformed and attached to a same document, but in several formats such as DOC, PDF, EXCEL, HTML, etc.

Each document is edited using its special-purpose editor (e.g. for HTML there are HTML editors such as FrontPage™ by Microsoft™. For Word documents that generate .DOC documents the typical tool is Microsoft Word™.). Accordingly, presently if one wishes to apply meta-data to all formats, as this meta-data reflects business rules, there is a need to re-program this meta-data separately for each specific application (document) format. This causes major inconsistencies and prevents actually using this additional layer. Since in the prior art tools for generating PDF and HTML documents there is no way to ensure that a same meta-data (such as said help features) which are programmed and generated once, can be used for both HTML, DOC and PDF, as these tools are specially tailored for each of said tools separately, it is desired to provide a single meta-data editor which is suitable for creating said meta-data layer once for all said various documents formats.

It is an object of the present invention to provide a non-programming interface for producing a document meta-data layer, which will be attached to the document and published according to the document format;

It is a particular object of the present invention to provide a tool for automatically associating help messages and rule-based content-sensitive meta-data to PDF documents;

It is still another object of the present invention to provide an editor for drafting and attaching to specific sections or fields of a PDF document meta-data comments within an additional layer, wherein said meta-data comments are optionally or selectively exposed to the user upon viewing the PDF document. The use of said editor does not require any programming capabilities from the editor user.

It is still another object of the present invention to provide a non-programming tool for generating content sensitive meta-data layer, i.e., a layer whose content depends on the content of the main document.

It is another object of the present invention to allow for editing the meta-data content once for all document formats, and then to transform the content to the desired program format according to the specific needs of that document format.

Other objects and advantages of the present invention will become apparent as the description proceeds.

### SUMMARY OF THE INVENTION

The present invention relates to a system for the preparation of an extended, two layer document, said extended document forms a single package which comprises a text document and a meta-data layer program attached to it, said system comprises a meta-data layer editor, which in turn comprises: (a) a document connector module for receiving a text document, and for parsing the document to document elements; (b) rules editor for defining rules concerning the content of each meta-data layer element, rules concerning to the form of appearance of each meta-data layer element, and action rules concerning conditions for activation of meta-data layer elements, wherein meta-data layer elements correspond to selected document elements of said locked text document; (c) program generator for generating from said rules an intermediate meta-data layer program; and wherein said system further comprises at least one converter for receiving a copy of said locked document and also receiving said intermediate program from said program generator, and for converting the same to said two layer extended document.

According to the invention said one or more converters are located internal or external of said meta-data layer editor.

In one embodiment, when a converter is located within said meta-data layer editor, it is used to output an extended document during early stages of the meta-data layer design. In that case, the input to the meta-data layer editor is generally a full text document.

Preferably, the system further comprises a GUI for interfacing with the meta-data layer creator.

Preferably, said meta-data layer editor is used off-line by a meta-data layer creator;

In a preferred embodiment, the system is used for serially preparing plurality of extended documents one at a time, wherein each document is customer specific, which further comprises: (a) a document processor for preparing one at a time an original customer specific document, said processor being in communication with a customer database and it also receives a document template, document preparation rules, and additional data, said original customer specific document being conveyed to a locking-publishing unit; (b) locking-publishing unit for receiving, one at a time, said original customer specific document, and for producing a locked document; (c) a meta-data layer processor for receiving one at a time said published locked document and said intermediate meta-data layer program, and using a converter, producing said two layer extended document.

In one embodiment, the converter which is used by the meta-data layer processor for producing said two layer extended document is external to the meta-data layer editor.

In one embodiment, the document which is used as an input to the editor during later stages of the meta-data layer design is a template locked document.

The invention also relates to a system for producing plurality of format versions of extended documents, wherein each of the one or more converters, whenever used, receives said intermediate program and plurality of format versions of documents, and it converts them to plurality of format versions two layer extended documents, all abiding the same set of meta-data rules, for correlated objects within the various versions.

Preferably, the meta-data layer within the extended document is a program coded in a software language which is suitable for activation by the corresponding viewer which displays said two layer documents.

Preferably, when the extended document is a PDF document, said software language is a first type of Java Script, when the extended document is an HTML document, said software language is a second type of Java Script, when the extended document is a WORD document, said software language is Visual Basic, and when the extended document is of another format, said software language is in another language which is suitable for activation by the viewer.

Preferably, the rules and actions together determine customer specific conditions for activation and corresponding content of each meta-data layer element, when the extended document is displayed by a corresponding viewer.

Preferably, the meta-data layer elements have a form of pop-up balloons.

In one embodiment of the invention, each of the extended documents is conveyed to a corresponding customer by email, and is viewed by the customer by means of a corresponding viewer. In another embodiment, each of the extended documents is saved within extended documents database at the company, and only a link to the respective document is sent to the customer by mail.

In one embodiment of the invention, the extended document is a bill, and the document processor is a bill processor.

Preferably, the meta-data layer of the extended document displays to the user who views the document a corresponding indicator, which when the user puts his mouse marker next to said indicator, the activation of a corresponding meta-data layer element occurs.

In a preferred embodiment, the extended document is a PDF extended document. In that case, the extended document is a two-layer PDF document, the locking-publishing unit is a PDF distiller. In another embodiment, the extended document is a WORD extended document. In still another embodiment, the extended document is an HTML extended document. In still another embodiment, the extended document is an EXCEL extended document.

In an embodiment of the invention, the meta-data layer editor and the meta-data layer processor are included within a meta-data layer manager.

Preferably, upon viewing of said extended document at a user viewer, the meta-data layer is also activated, and it selectively displays the meta-data elements to the user.

### BRIEF DESCRIPTION OF THE DRAWINGS

In the drawings:

FIG. 1 is a flow diagram illustrating a process for preparing a PDF locked document according to the prior art;

FIG. 2 is flow diagram illustrating a process for preparing PDF locked bills by a company, for mailing the same to customers according to the prior art;

FIG. 3 is a flow diagram illustrating a process for preparing an extended PDF extended document, which includes a locked PDF document and a meta-data layer, according to the present invention;

FIG. 4 is flow diagram illustrating in more detail a process for preparing by a company of an extended PDF bill, which includes a locked PDF bill and a meta-data layer, and mailing the same to a customer, according to the present invention;

FIGS. 5B, 5C, and 5D, provide an example of an extended PDF bill, as is viewed in various view stages by a customer. FIG. 5A shows a view of the same bill without the meta data layer, as is conventional;

FIG. 6A is a block diagram illustrating the structure and operation of the meta-data layer content editor, when producing a single format extended document; and

FIG. 6B is a block diagram illustrating the structure and operation of the meta-data layer content editor, when producing plurality of format versions of an extended document; and

FIG. 7 if a general flow diagram which describes the process for producing plurality of format versions of an extended document.

### DETAILED DESCRIPTION OF PREFERRED EMBODIMENTS

As is common in the art, a PDF file is a “locked” file which is constructed either from a document file which has been initially produced by means of an editor (e.g., a word processor such as WORD, or another editing program such as Excel, Power Point, etc.), or by means of a scanner which optically scanned the original document. There are several software packages that can produce a PDF file, for example, Adobe's Acrobat Writer, Adobe's Acrobat Distiller, or compatibles. The locked PDF file is essentially a true image of the original document. When the locked PDF file is opened by means of an appropriate viewer (such as Adobe's Acrobat Reader, or compatible), the image of the document is displayed to the user, exactly as produced. The term “locked” intends to indicate that the creator of the file is the only owner of the original file content. This is easily achieved by using PDF format that can be viewed, but cannot be modified. The locking of the PDF file therefore commonly serves the purpose of electronically storing and electronically transferring a true image of the original document. It should be noted that the present invention relates to any locked file format (such as HTML, DOC, XLS, etc.), whether scanned or otherwise constructed). For the sake of brevity, however, the description mostly refers to a locked file which is originally produced by means of an editing program (such as WORD), and is later converted to a locked PDF format document.

It should be noted that although the present invention, as described, mostly refers to a “locked” PDF format file (which is the most common format for locked documents), other file formats can also be considered as “locked”, particularly when one may need, if at all possible, special tools for opening the file for editing. For locking a file, one may also use watermarking, electronic signature, or other locking mechanisms to allow just content viewing of the document but no content modifications. Therefore, it should be noted that the present invention refers also to any such type of “locked” file, not only to a PDF “locked” file. The use of the invention in conjunction with PDF format documents is used herein only as one example.

As locking is sometimes not critical, more open formats can be relevant as well. In particular, HTML, XLS and DOC documents are examples of such relatively open formats. These formats still support separation between the core content (the locked layer), and other layers.

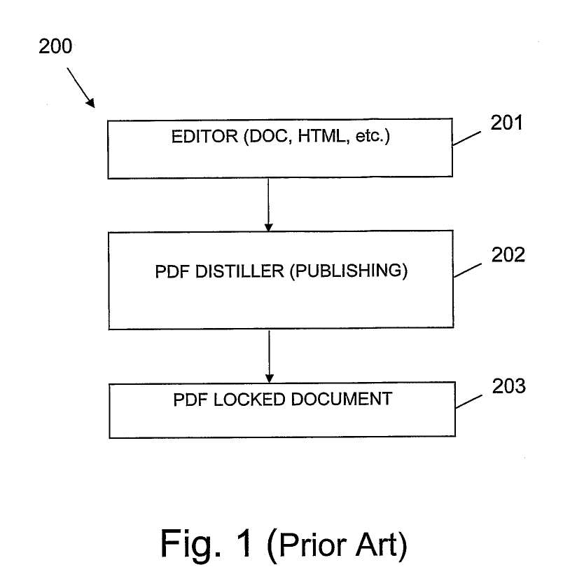

FIG. 1 shows a typical prior art two-stage system 200 for producing a PDF locked file from an editing program. In a first stage 201, a document file is prepared by means of an editor, such as a WORD editor, an HTML editor, Power Point editor, Excel editor, etc. When the editing of the document by editor 201 is completed and the file is ready in a corresponding DOC, HTML, XLS or JPG or GIF format, the file is transferred to a PDF distiller 202 for publishing, where the unlocked document is converted to a PDF locked document 203.

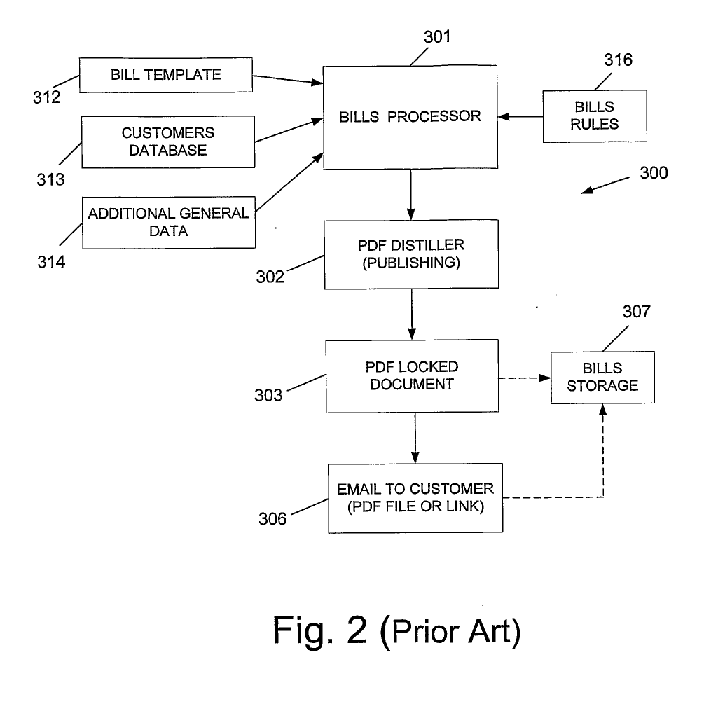

As previously mentioned in the “Background of the Invention” above, it has become common for companies to issue and electronically send documents such as bills to their customers in PDF locked format (or alternatively, a corresponding link to said bill which is stored at the company site). FIG. 2 illustrates in a block diagram form a typical prior art system 300 for issuing and sending bills in PDF format to customers. The system comprises bills processor 301, whose purpose is to produce a bill in a locked format for each specific customer. The operation of the bills processor 301 is governed by bill generation rules 316 which may be prepared by accounting department, customer management team, or marketing department, and may be updated from time to time. Said rules 316 may determine the date to issue the bill, a minimum charge for issuing a bill, specific bill format to specific types of customers, additional content associated with the bill, etc. The bills processor 301 receives inputs from essentially three sources as follows: (a) a bill template storage 312 which contains a basic template for the bill, or a storage of various templates to select from; (b) a customer database 313 which contains the current billing data of the relevant customer; and (c) additional general data 314 that has to be included in all bills (e.g., images, corporate logo, etc.).

Having the required inputs from said three resources 312, 313, and 314, the bills processor 301 produces a bill in some unlocked format. The file of the bill in the unlocked format is then conveyed to a PDF distiller 302 (or another compatible unit) for publishing. The PDF distiller 302 produces a PDF locked document 303, which reflects the exact image of the bill. During this process an explicit signature may be added by means of electronic signature or watermarking process (not shown).

The locked PDF bill is stored in bills storage 307. Then, a copy of the locked PDF bill is sent 306 to the customer by email, or alternatively, only a link to the bill in said storage 307 is sent by email to the customer.

As said, the Adobe's Acrobat Writer, and Adobe's Acrobat Reader are now provided with a Java Script module, enabling the attachment of a Java Script program to a locked PDF file. The Adobe's Acrobat Reader (i.e., viewer), accordingly, is now provided with a corresponding Java Script support module for reading and executing (interpreting) said attached Java Script program if and when attached to a PDF file.

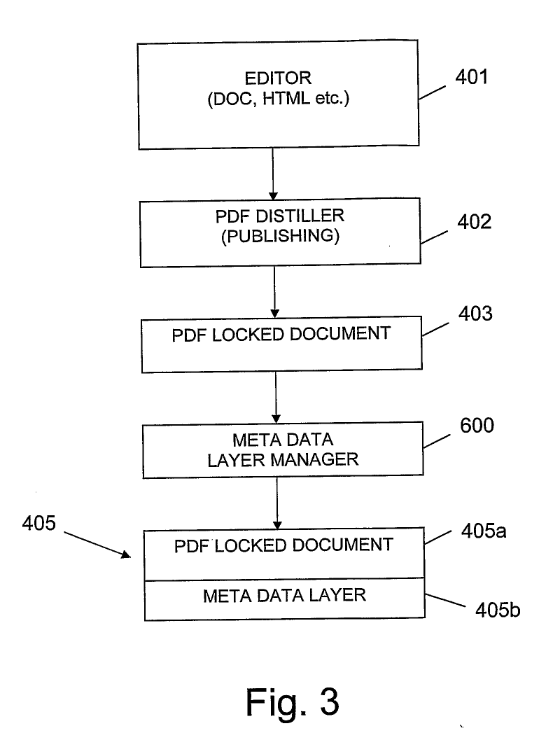

The following example of FIG. 3, which describes one usage of the present invention, relates to a visual content editor for adding a Java Script meta-data layer to a PDF locked document, therefore producing an enhanced PDF document. According to this example, the Java Script layer is added to the locked document after its publishing. In similar the prior art system of FIG. 1, the system of this example comprises an editor 401 for editing a typical document, and a PDF distiller 402 (or equivalent) which publishes the document in PDF locked format. In similar to the system of FIG. 1, the product of the PDF distiller 402 is a PDF locked document 403. The system of this example further comprises a meta-data layer manager 600 which includes editor for entering definitions of the metadata, which operates on said PDF locked document 403, and adds to it a Java Script layer of meta-data. The Java Script layer is attached to said PDF locked document 403, forming a package 405 of a PDF locked document 405a and a Java Script meta-data layer 405b. Hereinafter, said package of a PDF locked document and a Java Script meta-data layer will be referred to as “extended PDF package”. Said extended PDF package can now be electronically conveyed to another address in any conventional manner, such as by email. Similarly, for more general cases when other locked file formats are used, an “extended package” is created by meta-data layer manager 600. The format of the meta-data layer 405b depends on the file format and on the corresponding file viewer which is used. The essence of said meta-data layer and the manner of operation of said meta-data manager 600 will be described in more detail hereinafter.

One property of the meta-data layer manager 600 should be noted. Although for PDF documents its output is a Java Script add-on program to the locked PDF document, for other file formats, an add-on program of appropriate programming language must be generated. For example, for HTML document which is normally viewed by an Internet Browser, a different Java Script program must be generated. In another example, for a WORD viewer, a Visual Basic add-on program must be generated.

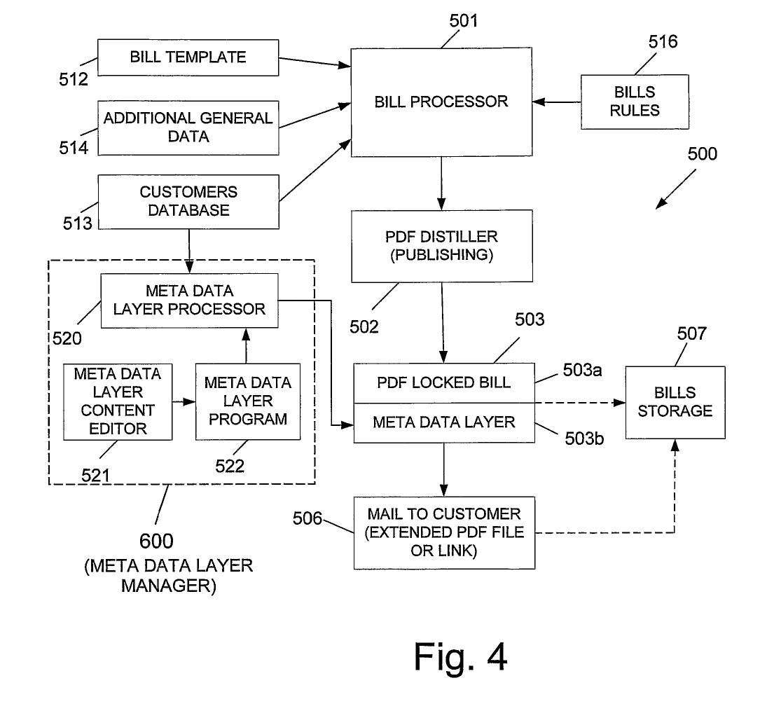

FIG. 4 illustrates in block diagram form a system 500 for automatically issuing extended PDF bills, according to an embodiment of the present invention. By “extended PDF bill” it is meant to refer to an electronic bill which has a form of extended PDF file, i.e., a bill file which comprises both a locked PDF document and a JAVA Script meta-data layer attached to it. The units 501, 502, 512, 513, 514, and 516 are essentially the same, and perform the same function as units 301, 302, 312, 313, 314, and 316 respectively of FIG. 2. Therefore, for the sake of brevity the functionality of said units will not be repeated here in detail. In addition, the system 500 comprises a meta-data layer manager 600. The meta-data layer manager 600 comprises meta-data layer processor 520 and meta-data layer content editor 521, for the preparation of a meta-data layer specific to each bill. For its operation, the meta-data layer processor 520 uses as input the meta-data program 522, which are typically pre-prepared and pre-updated generally by one or more of: a customer management team, a marketing team, etc. Said rules may define, for example, content sensitive generation rules: if the value of the total amount to pay in the bill is above $Y, generate a meta-data of form “A”, otherwise generate meta-data of form “B”. Various templates for the meta-data layer are initially prepared by one or more of said teams by means of meta-data content editor 521. As before, the bills processor 501 prepares the bill, and sends it to PDF distiller 502, which in turn issues a locked PDF file 503a of the bill. The meta-data layer processor 520, which as said uses the input program 522, similarly operates in communication with customers database 513, and prepares a Java Script meta-data layer 503b for each bill, which is based on the one or more templates as prepared by means of meta-data layer content editor 521, and which is specific to each customer. For example, based on the specific data of the customer (such as his previous background billing, the current bill value, etc.), the meta-data may include plurality of content elements, such as an element with a specific offer to the client, a help element which explains a specific data field (for example, a billing line) within the bill (which as said may also be specific to a customer, or even may depend on the specific customer familiarity level with the company bills), or it may provide him with another element that contains a link to a specific location within the company website to find more detailed explanations, etc. As in the system of FIG. 2, the extended PDF bill 503 (which includes the PDF locked bill 503a and the Java Script meta-data layer 503b) or a link to its copy as stored in the company bills storage 507, is conveyed to the customer by email 506. It should be noted that the meta-data layer editor may be either dedicated for a single specific format, or it may be generic for plurality of formats, as will be described later.

According to the present invention, upon activation of the PDF viewer by the customer, the JavaScript based meta-data layer is activated simultaneously with the locked PDF document. The meta-data layer, which is preferably divided into plurality of elements, is preferably not shown entirely on the screen. For example, a specific meta-data element may be positioned near a predetermined specific data (for example, a line or field) of the locked document to which it relates, and may be activated to be viewed by the user only when desired. For that purpose, the meta-data layer may include and display a predefined indicator (for example, “?”), for indicating that a further help or data can be provided. The user, when positioning his marking device (such as his mouse) on a specific marker, can activate the display of the corresponding meta-data element. The activation rules of each meta-data element are part of the meta-data layer rules.

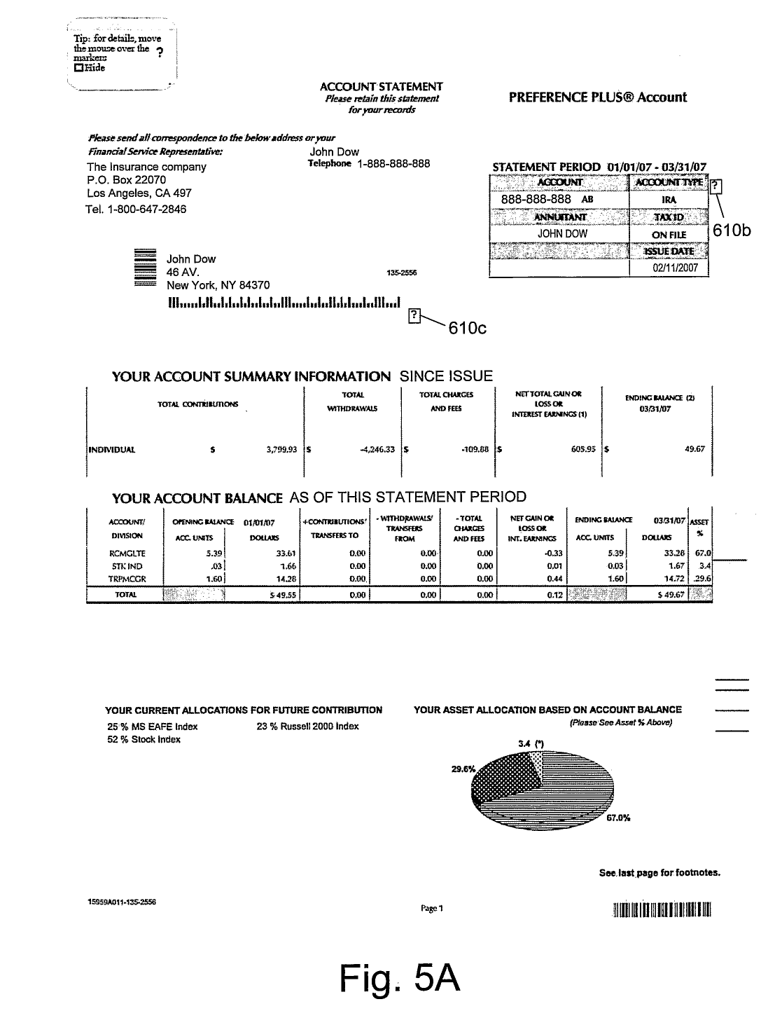

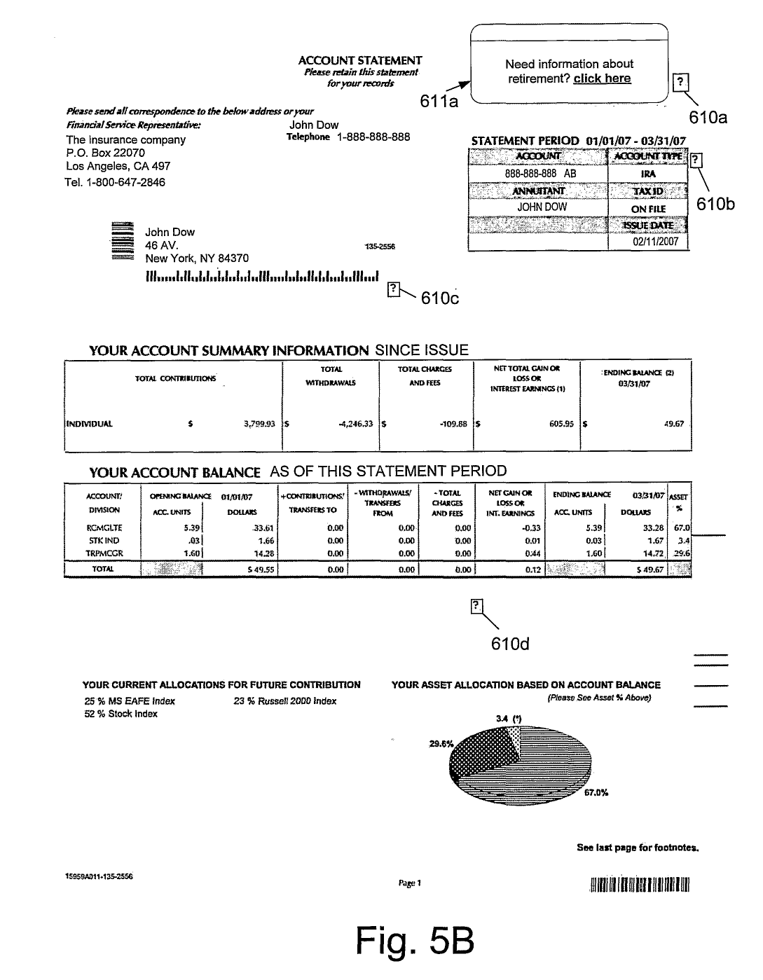

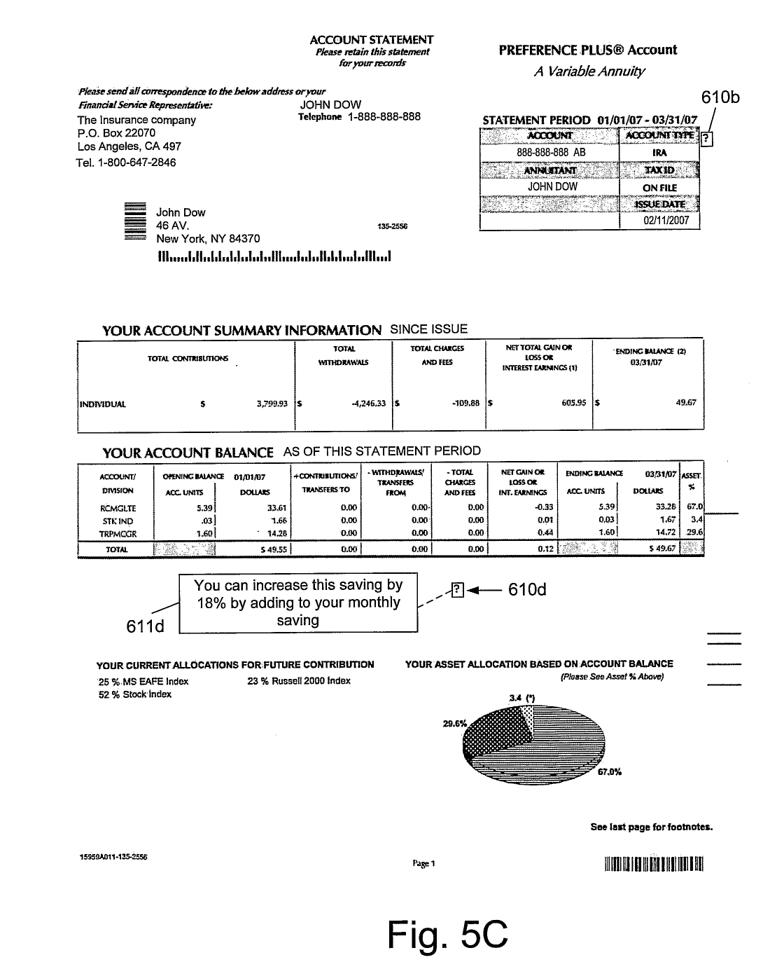

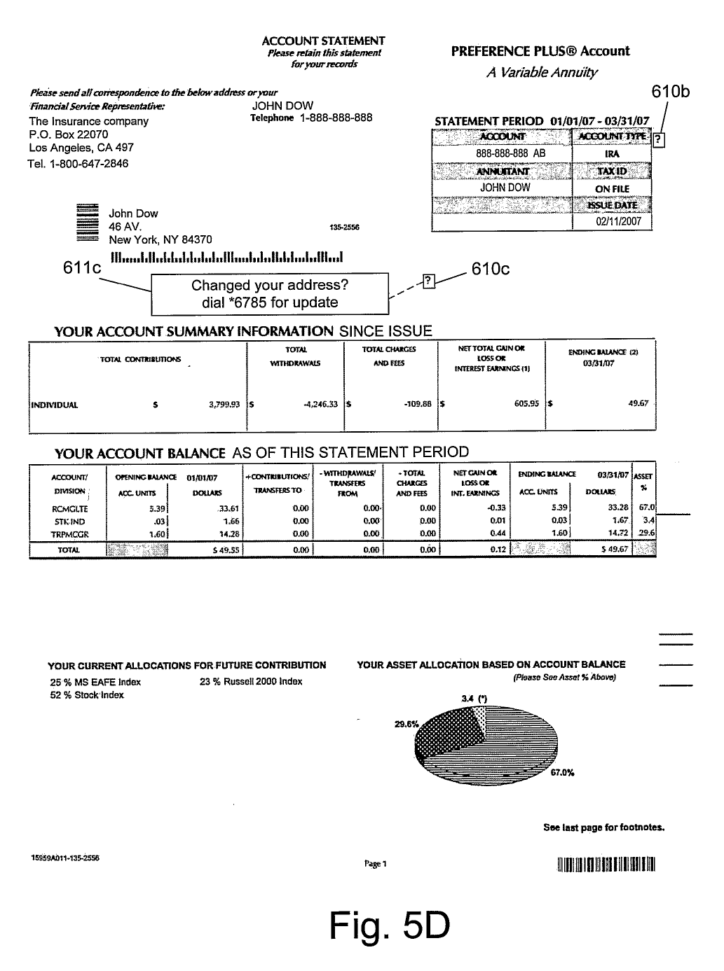

FIGS. 5A, 5B, 5C, and 5D provide an example for an extended PDF bill according to an embodiment of the present invention. FIG. 5A shows the original PDF bill, as is conventionally viewed by a PDF viewer. FIG. 5B shows the same bill, this time with the additional JavaScript layer, which displays several “?” indicators 610a-610d at specific locations of the bill. The user, when positioning his pointing device on a selected “?” indicator of the Java Script layer, activates a corresponding meta-data element, (in this case of a “balloon” type) of meta-data which appears and assists the user in understanding the document, or portions thereof, or refers him to some more help in the company web site. FIG. 5B shows the bill of FIG. 5A, when the balloon 611a relating to “?” indicator 610a is activated. This specific balloon is initially visible, in order to attract the user attention to the new capability of the invention. FIG. 5C shows another balloon 611d which in this case is design to attract the user to an additional marketing initiative of the company. FIG. 5D shows still another balloon 611c, which corresponds to “?” indicator 610c, and which is designed to guide the user in case of an address change.

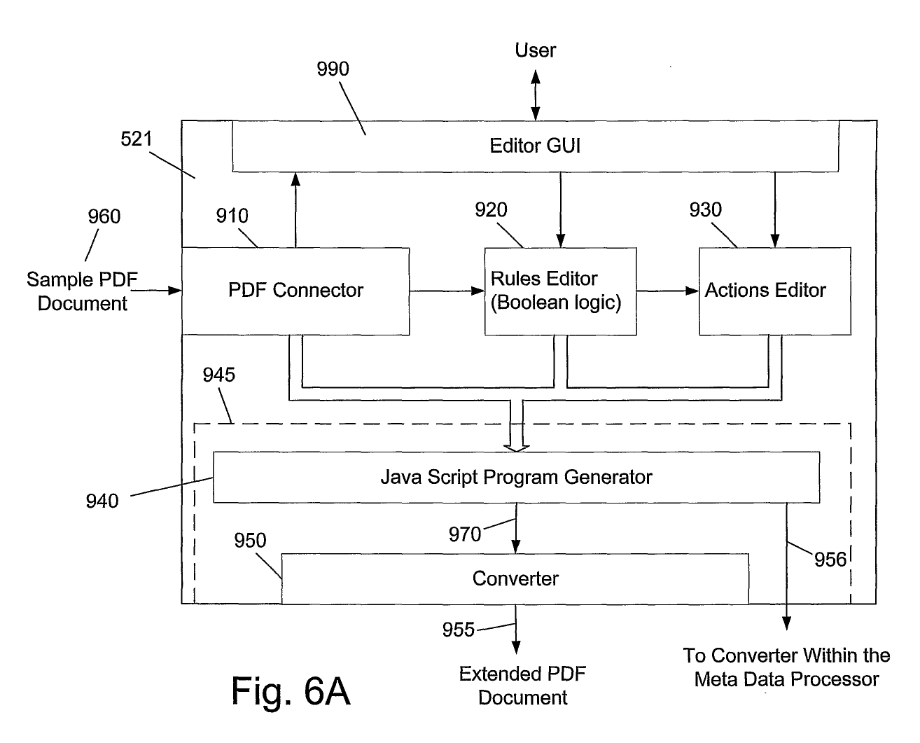

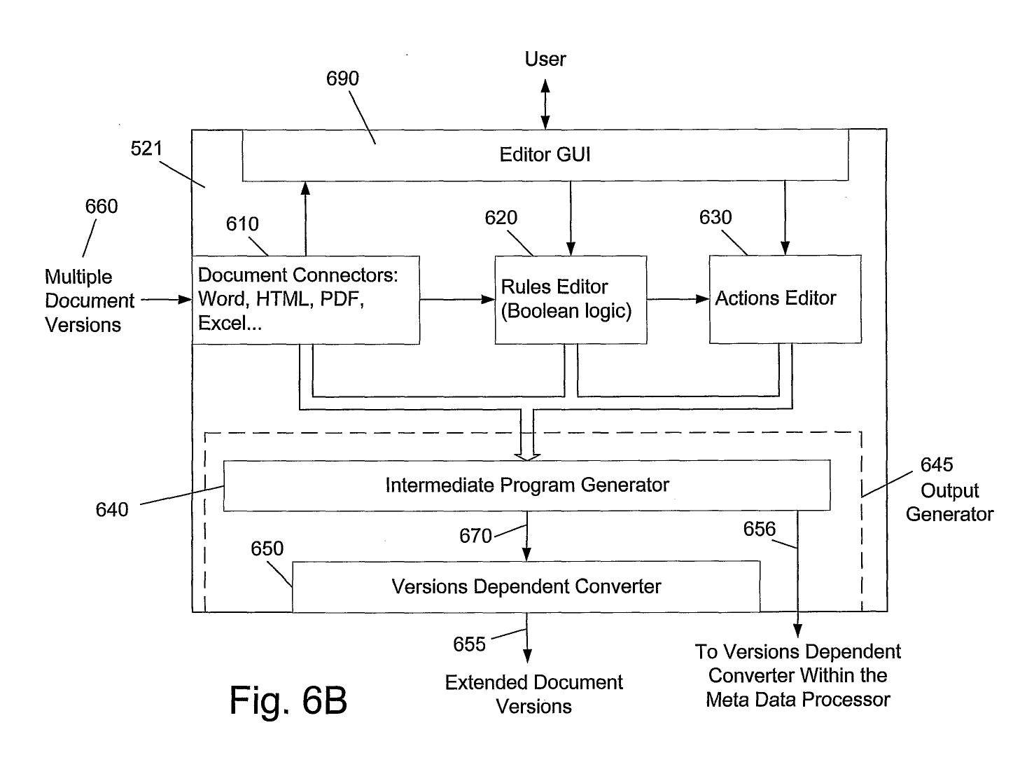

FIG. 6A provides in block diagram form a structure of one embodiment of meta-data layer content editor 521, which prepares a meta-data layer for a PDF document, and which can then be attach said layer to the document to form a PDF extended file. More specifically, this embodiment of the meta-data content editor 521 enables the user to define the elements of the meta-data layer (which as said may have the form of balloons that are activated when desired), the balloon contents and locations, and the rules which govern their appearance. Moreover, this is an editor, which can produce a meta-data program which is suitable for attachment to a PDF document. As the editing process of editor 521 is performed off-line, there are two manners of operations with editor 521. In a first manner, the input to the editor is a full PDF document. In that case, the output of editor 521 is an extended PDF document. This first manner of operation is generally useful during the early development stage of the meta-data layer. A second manner of operation with the meta-data content editor 521, which is performed during the later and final stages of the meta-data layer development involves inputting to the editor 521 a PDF template, and outputting a PDF program which is used during the online process flow to be attached to respectively to the various different PDF documents, for example to the various bills of the different company customers.

The editor GUI 990 is the interface with the meta-data content creator (hereinafter the “creator”) at the company who defines the various aspects relating to the document dependent meta-data layers. This GUI 990 enables him to prepare the meta-data layer, and to define the rules associated with the meta-data, and their actions. The scheme of FIG. 6A assumes that the creator wishes to obtain a meta-data layer for a document which has been saved in PDF format. The document, in PDF format is inputted into PDF connector module 610 (which in its more general term is also referred to herein as “document connector module”). The PDF connector module 610 parses the PDF document according to the document elements included in it (a document element is a specific data from within the document), and it builds an internal representation such as a table which summarizes the elements of the document. The table also includes for each document element, among other data, the location coordinates of each element. A document element within a bill may be, for example, the field of the “total to pay”. The location coordinates indicate the location of that field within the PFF document. In another example, a document element may be the address of the customer, and the location coordinates of this element are also provided. The location coordinates enable identifying the elements, and later on the extracting of the value of the document element (values such as $133, LA, etc.). Other characters of the elements, such as the color, the text, the text size, etc. may also be saved in the table. Having the table, one or more meta-data rules may be defined for each selected element. The rules and actions are defined by the user using rules editor 920 and actions editor 930 respectively. Once the creator completes editing the rules and the actions, the combination of all the information (object representation, rules and actions) needs to be transformed into a program—which is then saved in the meta-data program storage 522 (FIG. 4) which is external to meta-data layer content editor 521. As previously discussed, the rule may indicate that “if the value of element Y is Z, then perform action X”. The actions as defined by means of action editor 930 may indicate, for example, that a specific balloon (which is one type of a meta-data element) with a specific content should be activated, that a link should be displayed, or that a content within a specific balloon should be changed as indicated by a respective rule, etc. Furthermore, the actions may indicate how the balloons (or other meta-data information) may look like, for example in terms of its shape, color, size, etc.

The output generator 945, or more particularly the Java Script program generator 940 of the output generator, receives as an input the document itself in PDF format (from PDF connector 910), the rules associated with the document as defined by rule editor 920, and the corresponding actions for each of the rules as defined by actions editor 630. As said, there are two manners of operation in which the editor is used, depending on the inputted document. If the inputted document is a full document, for example, a specific bill which includes all the specific values in all fields, the output 955 from unit 521 is ready for operation extended document. As said, such manner of operation is useful generally in early stages of the meta-data layer definition. If, however, the inputted document is a template document, for example, a bill template which does not include specific values for the bill fields (such as the specific customer name, his address, and all other values specific to a specific bill), the output 956 from unit 521 is a Java Script intermediate program.

For the case where the inputted document 960 relates to a full document (in contrast to a document template), the operation of the output generator 945 is preferably performed in two phases, a first phase by Java Script program generator 940, and a second phase by converter 950. Upon receipt of the document from the PDF connector module 910, the defined rules from rules editor 920, and the corresponding actions from actions editor 930, the Java Script program generator 940 produces a Java Script program which describes all the activities expected from the meta-data layer, based on the predefined rules and actions, and with respect to the corresponding document. Said Java Script program 970 as produced by Java Script program generator 940 is provided into converter 950. Converter 950 attaches said Java Script program to the PDF file, thereby to produce the extended documents. As said, the above described two-phase process of the output generator 945 is suitable for the early stages of the editing of the meta-data layer, as it operates on a specific, full inputted document. The output of the two phase process of module 645 is not suitable for real time creation process of extended bills, as these bills are based on templates, to which specific data are fed in real time, according to the currently processed bill. For that purpose during a later stage of the editing process, the creator works on a template document which is inputted to PDF connector module 960 (this may be the same specific document, treated as if it was a template). The inputs to the output generator 945 are the same described. However, during said latter manner of operation, only the first stage (i.e., of the Java Script program generator 940) is used. The Java Script program 956, as created, is outputted to the meta-data layer processor 520 (FIG. 4). The meta-data layer processor 520 in turn also comprises a converter (not shown) essentially identical to the converter 950 of the meta-data layer editor 521, as described with respect to FIG. 6A. As previously said with respect to FIG. 4, the meta-data layer processor 520, produces in real time one at a time the various customer specific bills (or other documents) from templates, using the data specific to each customer, as stored in database 513. Having a specific bill (or another specific document, as is the case) on one hand, and the Java Script program 956 on the other hand, the converter which is within the meta-data layer processor 520 produces the extended bills (or documents) one at a time. In other words, it produces one at a time a specific extended PDF bill (or document), which comprises a PDF document to which a corresponding Java Script program is attached to produce assistance in a different layer and enrich the understanding of the layer by the receiving customers.

FIG. 6B provides in block diagram form a structure of a generic meta-data layer content editor 521, which is capable of preparing a meta-data layer once for a specific document, and which can then be attached to the document to form an extended file in one specific format, or in more than one format as selected. More specifically, the meta-data content editor 521 enables the user to define the elements of the meta-data layer (which as said may have the form of balloons that are activated when desired), the balloon contents and locations, and the rules which govern their appearance. Moreover, and as said, this is a generic editor, which can produce an intermediate meta-data program once, which can then be transformed to various format dependent programs, that are suitable for attachment to various types of format documents and thereby to produce plurality of format versions of documents. Furthermore, it should be noted that the editing process of editor 521 is performed off-line.

The editor GUI 690 is the interface with the meta-data content creator (hereinafter the “creator”) at the company who defines the various aspects relating to the document dependent meta-data layers. This GUI 690 enables him to prepare the meta-data layer, and to define the rules associated with the meta-data, and their actions. The scheme of FIG. 6B assumes that the creator wishes to obtain a meta-data layer for a document which has been saved in several formats (for example a document saved in PDF, HTML and WORD. Hereinafter, the various formats of a same document will be referred to as “versions”). The versions of the document, as saved in said several formats are inputted into technology connectors module 610. The technology connectors module 610 parses each of the versions of the document according to the elements included in them, and builds a table which correlates between the document elements of the different versions (as said the various versions relate to a same document). The table also includes for each document element, among other data, the location coordinates of each element. An element within a bill may be, for example, the field of the “total to pay”. The location coordinates are provided for each version and they indicate the location of that field within each document version. In another example, a document element may be the address of the customer, and the location coordinates of this element are also provided. The location coordinates enable identifying the elements in each version, and later on the extracting of the value of the document element (values such as $133, LA, etc.). Other characters of the document elements, such as the color, the text, the text size, etc. may also be saved and correlated in the table. Having the table, one or more meta-data rules may be defined for each selected document element. The rules and actions are defined by the user using rules editor 620 and actions editor 630 respectively. Once the creator completes editing the rules and the actions, the combination of all the information (object representation, rules and actions) needs to be transformed into a program—which is then saved in the meta-data program storage 522 (FIG. 4) which is external to meta-data layer content editor 521. As previously discussed, the rule may indicate that “if the value of element Y is Z, then perform action X”. The actions as defined by means of action editor 630 may indicate, for example, that a specific balloon with a specific content should be activated, that a link should be displayed, or that a content within a specific balloon should be changed as indicated by a respective rule, etc. Furthermore, the actions may indicate how the balloons (or other meta-data information) may look like, for example in terms of its shape, color, size, etc.

The output generator 645, or more particularly the intermediate program generator 640 of the output generator, receives as an input for each inputted document version (for example, the versions 660 of the currently processed document may be PDF, EXCEL, Word, and HTML), the document version itself, the rules associated with the document as defined by rule editor 620, and the corresponding actions for each of the rules as defined by actions editor 630. As will be shown, there may be two manners of operation in which the editor is used, depending on the inputted document. If the inputted document (i.e., the document from which the inputted document versions 660 to module 610 were produced) is a full document, for example, a specific bill which includes all the specific values in all fields, the output 655 from unit 521 is plurality of ready for operation extended document versions. Such manner of operation is useful generally in early stages of the meta-data layer definition. If, however, the inputted document (i.e., the document from which the various inputted document versions 660 to module 610 were produced) is a template document, for example, a bill template which does not include the specific values for the bill fields (such as the specific customer name, his address, and all other values), the output 656 from unit 521 is a generic, intermediate program.

For the case where the inputted document versions 660 relate to a full document (in contrast to a document template), the operation of the output generator 645 is preferably performed in two phases, a first phase by Intermediate Program Generator 640, and a second phase by Versions Dependent Converter 650. Upon receipt of the document versions (for example, one at a time) from the technology connectors module 610, the defined rules from rules editor 620, and the corresponding actions from actions editor 630, the intermediate program generator 640 produces a generic, intermediate program which describes all the activities expected from the meta-data layer, based on the predefined rules and actions, and with respect to the corresponding document. This program is generic in terms of the document versions as it does not relate specifically to any of the PDF, WORD, EXCEL, or HTML, versions etc. The program is intermediate in terms of its functionality, as it is not the final program which is attached to any of the document versions for producing any version of a final extended document. Said generic, intermediate program 670 as produced by intermediate program generator 640 is provided into Versions Dependent Converter 650. Versions Dependent Converter 650 converts said generic, intermediate program to plurality of programs, each relating to a single format version of the document. As said, a PDF document needs the program to be coded in JavaScript, HTML needs the program to be coded in another type of JavaScript, WORD and Excel documents need the program to be coded in Visual Basic. In other words, Versions Dependent Converter 650 produces several programs, suitable for all the program versions respectively. The versions dependent converter 650 also attaches respectively each of the format dependent programs as produced to its corresponding document version, thereby to produce the various final extended documents (i.e., extended PDF document, extended Word document, extended EXCEL document, extended HTML document, etc.). As said, the two phases of the process as performed by the output generator 645 enable the production of the plurality of extended documents, while producing a generic, intermediate program only once, with no need to produce such program separately for each format (version) of the document. As said, the above described two-phase process of the output generator 645 is suitable for the early stages of the editing of the meta-data layer, as it operates on a specific, full inputted document (although in several inputted formats). The output of the two phase process of module 645 is not suitable for real time creation process of extended bills, as these bills are based on templates, to which specific data are fed. For that purpose during a later stage of the editing process, the creator works on a template document for which multiple document versions 660 are inputted to the technology connectors module 660 (this may be the same specific document, treated as if it was a template). The inputs to the output Generator 645 are the same described. However, during said latter manner of operation, only the first stage (i.e., of the intermediate program generator 640) is used. The intermediate, generic program 656, as created, is outputted to the meta-data layer processor 520 (FIG. 4). The meta-data layer processor 520 in turn also comprises versions dependent converter (not shown) essentially identical to the versions dependent converter 650 of the meta-data layer editor 521, as described with respect to FIG. 6B. As previously said with respect to FIG. 4, the meta-data layer processor 520, produces in real time one at a time the various customers specific bills (or other documents) from templates, using the data specific to each customer, as stored in database 513. Having a specific bill (or another specific document, as is the case) in various versions on one hand, and the generic intermediate program 656 on the other hand, the versions dependent converter which is within the meta-data layer processor 520 produces the various extended versions of the bill (or document). In other words, it produces one at a time a specific extended bill (or document) in various different formats, each version includes attached to it a corresponding program (Java Script for PDF, Java Script, however different from the one of the PDF, for the HTML, Visual Basic for Word, etc.)

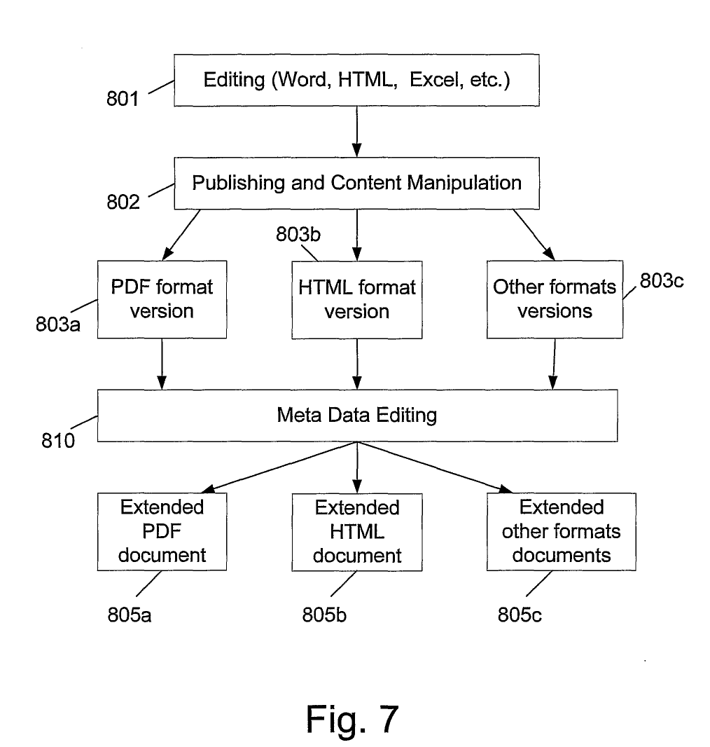

FIG. 7 describes the process of producing plurality of extended document versions as described above with respect to FIG. 6B. The process is similar to the process of FIG. 3, however, while the process of FIG. 3 relates to the production of a single format extended document (in the case of FIG. 3 an extended PDF document), the process of FIG. 7 relates to the production of plurality of document versions, in a manner which is preferable by the process of the present invention. In step 801, plurality of the document versions are produced, for example, PDF, Word, HTML, and EXCEL format versions of the document. Step 802 publishes the document in the various versions by performing a process as described with respect to units 501, 502, 512, 513, 514, and 516 of FIG. 4, and later performing “save as” of the published document for each corresponding version. The result of the publishing process 802 is therefore plurality of versions of the document, for example, a PDF format version 803a, a Word format version 803b, and other format versions 803c. The process is then continues by performing meta-data editing 810, a process as described above with respect to meta-data layer editor 521, within meta-data layer manger 600. As mentioned with respect to FIG. 6B, most of the meta-data editing procedure within step 810 is produced only once by producing an intermediate generic program (by converter 640 of FIG. 6B), and which is then converted to plurality of specific format programs that are then attached to the various formats document versions 803a, 803b, 803c, etc., to produce plurality of extended documents, extended PDF document 805a, extended HTML document 805b, and extended other format documents 805c.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. System for the preparation of an extended, two layer electronic document, said extended document having the form of a single package which comprises a text document and a meta-data layer program attached to it, said system comprises a meta-data layer editor, which in turn comprises:
a document connector module for receiving a text document, and for parsing the document to document elements;
meta data layer editor for defining rules concerning the content of each meta-data layer element, rules concerning to the form of appearance of each meta-data layer element, and action rules concerning conditions for activation of meta-data layer elements, wherein meta-data layer elements correspond to selected document elements of said text document; and,
program generator for generating from said rules an intermediate meta-data layer program;
wherein said system further comprises at least one converter for receiving a copy of said text document and also receiving said intermediate program from said program generator, and for converting the same to said two layer extended document.

2. System according to claim 1, wherein said one or more converters are located internal or external of said meta-data layer editor.

3. System according to claim 1, wherein when a converter is located within said meta-data layer editor, it is used to output an extended document during early stages of the meta-data layer design.

4. System according to claim 3, wherein the input to the meta-data layer editor is a full text document.

5. System according to claim 1, further comprising a GUI for interfacing with the meta-data layer editor.

6. System according to claim 1, wherein said meta-data layer editor is used off-line by a meta-data layer creator;

7. System according to claim 1, which is used for serially preparing plurality of extended documents one at a time, wherein each document is customer specific, which further comprises:
a document processor for preparing one at a time an original customer specific document, said processor being in communication with a customer database and it also receives a document template, document preparation rules, and additional data, said original customer specific document being conveyed to a locking-publishing unit;
locking-publishing unit for receiving, one at a time, said original customer specific document, and for producing a locked document;
a meta-data layer processor for receiving one at a time said published locked document and said intermediate meta-data layer program, and using a converter, producing said two layer extended document.

8. System according to claim 7, wherein the converter which is used by the meta-data layer processor for producing said two layer extended document is external to the meta-data layer editor.

9. System according to claim 7, wherein the document which is used as an input to the editor during later stages of the meta-data layer design is a template locked document.

10. System according to claim 1, for producing plurality of format versions of extended documents, wherein each of the one or more converters, whenever used, receives said intermediate program and plurality of format versions of documents, and it converts them to plurality of format versions two layer extended documents, all abiding the same set of meta-data rules, for correlated objects within the various versions.

11. System according to claim 1, wherein the meta-data layer within the extended document is a program coded in a software language which is suitable for activation by a corresponding viewer which displays said two layer documents.

12. System according to claim 11, wherein when the extended document is a PDF document, said software language is a first type of Java Script, when the extended document is an HTML document, said software language is a second type of Java Script, when the extended document is a WORD document, said software language is Visual Basic, and when the extended document is of another format, said software language is in another language which is suitable for activation by the viewer.

13. System according to claim 7, wherein the rules and actions together determine customer specific conditions for activation and corresponding content of each meta-data layer element, when the extended document is displayed by a corresponding viewer.

14. System according to claim 1, wherein the meta-data layer elements have a form of pop-up balloons.

15. System according to claim 7, wherein each of the extended documents is conveyed to a corresponding customer by email, and is viewed by the customer by means of a corresponding viewer.

16. System according to claim 7, wherein each of the extended documents is saved within extended documents database at the company, and only a link to the respective document is sent to the customer by mail.

17. System according to claim 7, wherein the extended document is a bill, and wherein the document processor is a bill processor.

18. System according to claim 1, wherein the meta-data layer of the extended document displays to the user who views the document a corresponding indicator, which when the user puts his mouse marker next to said indicator, the activation of a corresponding meta-data layer element occurs.

19. System according to claim 1, wherein the extended document is a PDF extended document.

20. System according to claim 1, wherein the extended document is a WORD extended document.

21. System according to claim 1, wherein the extended document is an HTML extended document.

22. System according to claim 1, wherein the extended document is an EXCEL extended document.

23. System according to claim 7, wherein when the extended document is a two-layer PDF document, the locking-publishing unit is a PDF distiller.

24. System according to claim 7, wherein said meta-data layer editor and said meta-data layer processor are included within a meta-data layer manager.

25. System according to claim 1, wherein upon viewing of said extended document at a user viewer, activating also said meta-data layer, and selectively displaying said meta-data elements to the user.
